(19) United States
(12) Patent Application Publication
(10) Pub. No.: US 2007/0101967 A1
(43) Pub. Date: May 10, 2007

(54) ENGINE AND A METHOD OF MAKING SAME

(76) Inventor: Ian Pegg, Chelmsford (GB)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/556,237

(22) Filed: Nov. 3, 2006

(30) Foreign Application Priority Data
Nov. 5, 2005 (GB) 0522643.6

(51) Int. Cl. F01M 3/04; F02F 3/00

(52) U.S. Cl. 123/196 M; 123/193.4

(57) ABSTRACT

An internal combustion engine is provided having at least one cylinder bore for slidingly supporting a piston, the cylinder bore wall of the at least one cylinder of the engine having pockets formed therein for retaining lubricant to reduce friction between the cylinder bore wall and piston. The pockets are elongate and have axes which are substantially parallel to the axis of the cylinder bore. The pockets are located at a first region supporting the piston when the piston is at its top dead center position. A method of making the cylinder is also provided.

### FIELD OF THE INVENTION

This invention relates to an internal combustion engine and in particular to method and a system for manufacturing an internal combustion engine.

### BACKGROUND AND SUMMARY OF THE INVENTION

It is known that it is necessary to have a certain degree of roughness on each cylinder wall of an engine in order to retain oil used as a lubricant between the cylinder wall and the piston which is slidingly engaged within the respective cylinder. In practice the surface of the cylinder wall comprises a number of peaks and troughs and the oil is stored within the troughs. It is further well known in the manufacture of internal combustion engines to use a honing process to produce a desired surface finish on the wall of each cylinder of the engine in order to provide such an oil retention surface.

DE19614328 describes a process for the fine machining of work piece surfaces by means of laser beams to generate a regular surface finish. Various examples are given of the surface finishes which may be created by the process described.

U.S. Pat. No. 5,655,955 describes a process of axial honing of cylinder bore walls to create axial tracks or grooves. A problem encountered with cylinder walls having grooves created in this manner is that, in use, continuous grooves encourage blow-by of exhaust gases past the piston rings. A further problem is that cylinder wall scuffing tends to occur when there is no discontinuity in the cylinder wall surface in the direction of travel of the piston. For these reasons, manufacturers tend to use a cross hatching honing process on cylinder walls to create a surface finish comprising grooves typically oriented between 45° and 60° to the axis of the cylinder bore.

While conventional cross hatch honing creates cylinder walls having good oil retention and giving reasonable piston friction characteristics, piston friction remains a major contributor to fuel consumption in internal combustion engines. It is therefore desirable to further reduce the cylinder-piston friction and wear characteristics.

The inventor herein has realized that it is possible to obtain reduced piston friction and wear characteristics without penalizing oil consumption by use of elongate pockets having axes which are substantially parallel to the axis of the cylinder bore to the regions supporting the piston when at top dead center and bottom dead center.

Accordingly, there is provided an internal combustion engine having at least one cylinder bore said cylinder bore having a wall for slidingly supporting a piston, said wall having pockets formed therein for retaining lubricant to reduce friction between the cylinder bore and piston, wherein said pockets are elongate and have axes which are substantially parallel to axis of said cylinder bore, said pockets being located at a first region of said wall supporting the piston when said piston is at its top dead center position.

In one embodiment of the present invention, the pockets are between 5 and 60 μm deep, between 0.1 and 4 mm long, and between 5 and 90 μm wide.

In an alternative embodiment, the pockets are between 5 and 30 μm deep, between 0.5 and 2 mm long, and between 30 and 90 μm wide.

In yet another alternative embodiment, the pockets are spaced between 0.5 and 2 mm apart.

In another alternative embodiment, pockets adjacent to each other in an axial direction are radially staggered with their axes offset from each other.

In yet another embodiment, the pockets are located at a second region supporting the piston when the piston is at its bottom dead center position.

The cylinder bore wall of the at least one cylinder of the engine may have a different surface relief formed therein outside the first and/or second region(s). In an alternative embodiment, the surface relief formed in the cylinder bore wall outside the first and/or second region(s) comprises grooves or secondary pockets having axes which are at an angle of 45° or more to the axis of the cylinder bore. In another embodiment, the axes of the grooves or secondary pockets are substantially 90° to the axis of the cylinder bore.

According to another embodiment of the present invention, there is provided a method for manufacturing a cylinder for an internal combustion engine, the method including: producing a cylinder bore wall with a required diameter and roundness; and machining pockets in said cylinder bore wall, which pockets, in use, retain lubricant to reduce friction between said cylinder bore and a piston slidingly supported by said cylinder bore, characterised in that said pockets are elongate and formed with axes which are substantially parallel to the axis of said cylinder bore, said pockets being machined at a first region which, in use, supports said piston when said piston is at its top dead center position.

Suitably, the pockets are machined with a depth of between 5 and 60 μm, a length of between 0.1 and 4 mm, and a width of between 5 and 90 μm. In an alternative embodiment, the pockets are machined with a depth of between 5 and 30 μm, a length of between 0.5 and 2 mm, and a width of between 30 and 90 μm.

In yet another alternative embodiment, the pockets are machined between 0.5 and 2 mm apart.

In another alternative embodiment, pockets are machined adjacent to each other in an axial direction with their axes offset from each other.

Alternatively, the pockets are machined at a second region which, in use, supports the piston when the piston is at its bottom dead center position.

The cylinder bore wall may be machined with a different surface relief outside the first and/or second region(s). In one embodiment of the present invention, grooves or secondary pockets having axes which are at an angle of 45° or more to the axis of the cylinder bore are machined in the cylinder bore wall outside the first and/or second region(s). In an alternative embodiment, the grooves or secondary pockets are machined with axes at an angle of substantially 90° to the axis of the cylinder bore.

In one embodiment of the invention, the pockets are machined by honing, and preferably by laser honing.

It will be appreciated that features of the invention are susceptible to being combined in any combination without departing from the scope of the invention as defined by the accompanying claims.

### BRIEF DESCRIPTION OF THE DRAWINGS

By way of example only, embodiments of the present invention will now be described with reference to the accompanying drawings wherein:

FIG. 1 is a cross-section through one cylinder of an engine showing the piston occupying its top dead center position;

FIG. 2 is a cross-section through one cylinder of an engine showing the piston occupying its bottom dead center position;

FIG. 3 is a view of a portion of the cylinder bore wall of the cylinder shown in FIGS. 1 and 2 showing a pattern of oil retention pockets; and

FIG. 4 is a view of a portion of the cylinder bore wall of the cylinder shown in FIGS. 1 and 2 showing a pattern of oil retention grooves.

### DESCRIPTION OF PREFERRED EMBODIMENT(S)

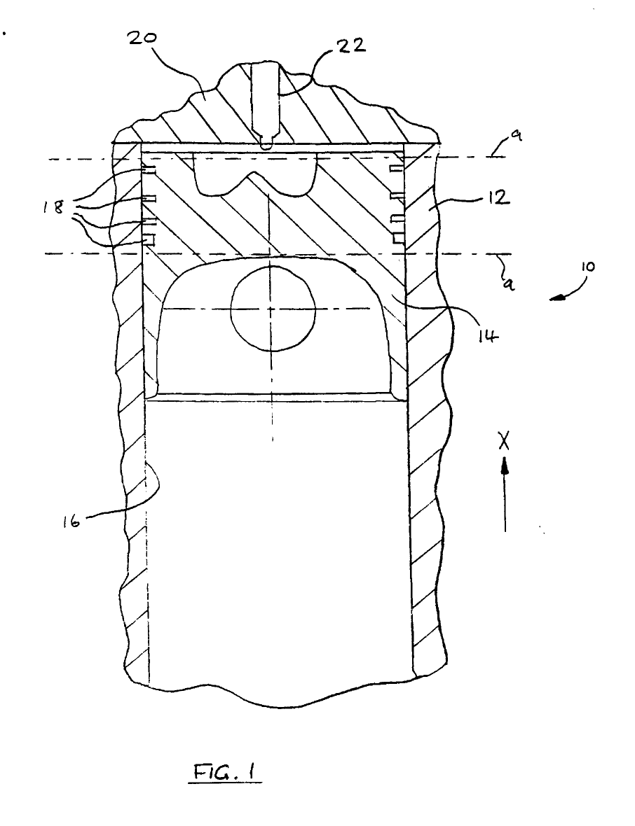

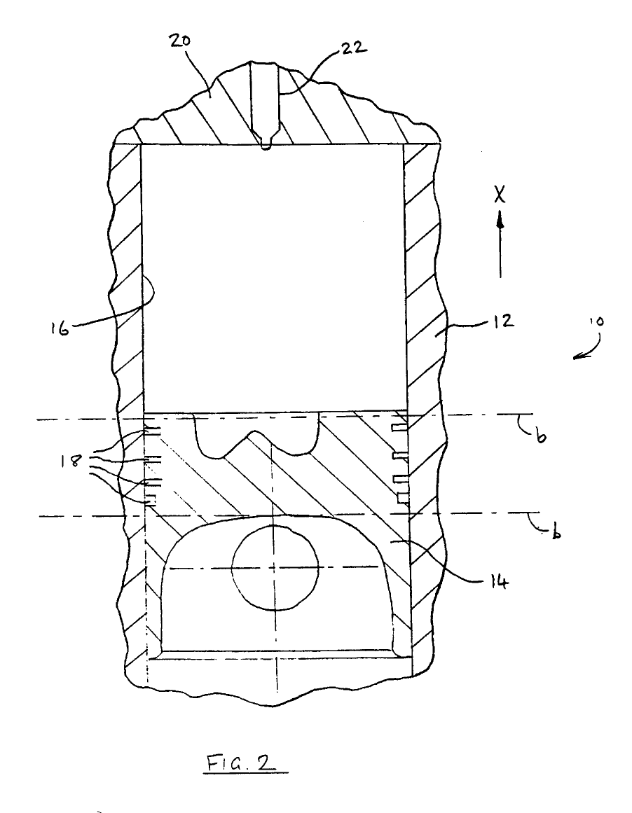

With reference to FIGS. 1 and 2 there is shown a section through one cylinder 10 of a multi-cylinder diesel internal combustion engine. The cylinder 10 is formed within a cylinder block 12 of the engine, and a piston 14 is slidingly supported by the cylinder bore wall 16 and has a number of piston rings 18 to provide a seal between the piston 14 and the cylinder bore wall 16. FIG. 1 shows the cylinder 10 with the piston 14 occupying its top dead center position, while FIG. 2 shows the cylinder 10 with the piston 14 occupying its bottom dead center position.

A cylinder head 20 is attached to the cylinder block 12 by way of fasteners (not shown) to close of the upper end of the cylinder 10 and supports a number of valves (not shown) to selectively admit air into the cylinder 10 and to selectively allow exhaust gases to flow out of the cylinder 10. A fuel injector nozzle 22 is supported by the cylinder head 20 for injecting fuel into the cylinder 10.

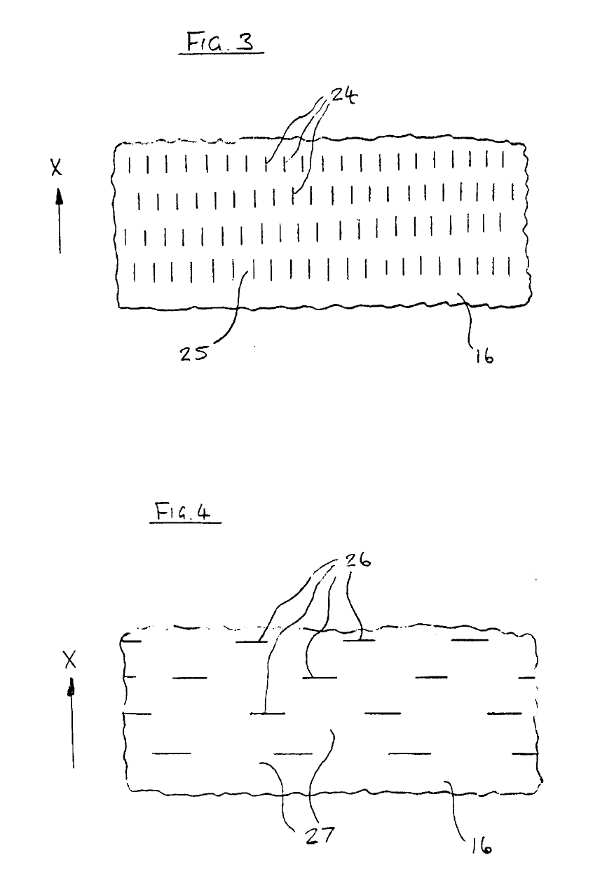

As depicted in FIG. 3, the cylinder bore wall 16 has number of regularly spaced pockets 24 formed therein at the ring reversal regions. The ring reversal regions are the regions of the cylinder bore wall which are occupied by the piston rings 18 as the direction of motion of the piston reverses during operation of the engine when the piston is in its top dead center and bottom dead center positions. The ring reversal region corresponding to the piston top dead center position is shown as the region between the markings ‘a’ in FIG. 1, and the ring reversal region corresponding to the piston bottom dead center position is shown as the region between the markings ‘b’ in FIG. 2. The pockets 24 are elongate with their axes oriented substantially parallel to the axis of the cylinder bore, though the axes of the pockets 24 could be anything up to 10° to the axis of the cylinder bore, the axis of the cylinder bore being indicated by arrow ‘X’ in the figures. Each pocket 24 has a depth of approximately 20 μm, a length of approximately 1 mm and a width of approximately 60 μm. The pockets are spaced around the cylinder bore wall approximately 1 mm apart from each other in radial and axial directions with respect to the cylinder bore, with axially adjacent pockets being radially staggered such that their axes are offset from each other. Although the pockets could be formed only in the ring reversal region ‘a’ corresponding to the piston top dead center position where the piston 14 is subject to higher load than in its bottom dead center position, for the purposes of this example the pockets are formed in both ring reversal regions ‘a’ and ‘b’.

Surrounding each pocket is a very smooth surface 25 having a surface texture of less than 0.1 μm Ra. Ra is a measurement of the average distance between the median line of the surface profile and its peaks and troughs as set down in British Standard BS1134.

Outside the ring reversal regions ‘a’ and ‘b’, the cylinder bore wall 16 is formed with a different surface relief, in this case regularly spaced secondary pockets 26. The secondary pockets 26 have axes which are at an angle of substantially 90° to the axis of the cylinder bore as shown in FIG. 4. Each secondary pocket 26 has a depth of approximately 20 cm, a length of approximately 1 mm, and a width of approximately 60 cm. The secondary pockets are spaced approximately 3 mm apart from each other in radial and axial directions with respect to the cylinder bore. Between each secondary pocket 26 is a relatively smooth surface 27 having a surface texture of less than 0.1 μm Ra. The secondary pockets 26 described herein are by way of example only, and it will be appreciated that alternate surface relief features could be used as are known, for example from DE 19614328, including cross hatching and grooves.

It will be appreciated that the dimensions and surface finish provided above are by way of example and that alternative dimensions and surface finishes could be used for different applications.

During operation of the engine, as the piston 14 moves between its bottom dead center and top dead center positions, the piston and piston rings 18 slide along the cylinder bore wall 16 and are subject to hydrodynamic lubrication from oil retained in the secondary pockets 26 outside the ring reversal regions ‘a’ and ‘b’. Conventional surface relief features, such as the secondary pockets 26 having axes at substantially 90° to the direction of travel of the piston as illustrated or continuous grooves, are known to provide low friction under hydrodynamic lubrication. Without surface relief features, the lack of discontinuities on very smooth surface finishes results in bore scuffing, since the oil surface tension prevents ‘wetting’ of the smooth surface. On the other hand, the rougher the surface, the greater the oil consumption and the higher the friction.

As the piston 14 approaches its bottom dead center and top dead center positions, the relative velocity of the piston rapidly decreases down to zero at bottom dead center and top dead center. In these regions, the effect of hydrodynamic lubrication also rapidly decreases and the effect of mixed lubrication becomes prevalent. The inventor has now found that in the ring reversal regions, elongate pockets 24 of the type described with their axes between 0° and 10° to the direction of motion of the piston provide an advantageous source of lubrication for the piston rings 18, yet allow for use of a very smooth surface finish (Ra<0.1 μm) surrounding each pocket, so ensuring low oil consumption. This combination of pockets with very smooth surface finish provides for low oil consumption together with lower friction and wear characteristics than conventional cylinder bore wall surface relief features. The use of pockets 24 rather than grooves reduces the tendency for scuffing and blow-by, a phenomenon which is encouraged by continuous grooves parallel to the axis of the cylinder bore. The cylinder bore wall so machined therefore takes advantage of the prevalent lubrication effects at different regions to reduce friction, wear and oil consumption.

The cylinder block 12 may be machined to produce the cylinder bore wall surface finish according to the following method:
a) drill or turn the block to form cylinder bore of required diameter and roundness;
b) rough hone cylinder bore wall using diamond stones or ceramic in conventional cross hatch manner at between 45° and 60° to the axis of the cylinder bore;
c) machine elongate pockets 24 in ring reversal regions ‘a’ and ‘b’, and secondary pockets 26 outside ring reversal regions using laser honing method (as described in DE 19614328); and
d) fine hone cylinder bore to produce smooth surface (Ra<0.1 μm) using conventional honing method in a normal cross hatch manner at 45 to 60 degrees to the axis of the cylinder bore. This also removes any material displaced onto the surface which could cause wear.

It is preferred to use a laser machining process to produce the pockets 24 and secondary pockets 26 in an otherwise smooth surface. This is because such a laser machining process allows each pocket to be accurately produced and also the use of laser machining permits considerable flexibility in the location size, shape and orientation of the pockets. However, it will be appreciated that alternative fine honing and/or pocket machining methods such as electron beam or other suitable mechanical honing methods could be used instead of the laser honing method.

It will be appreciated by those skilled in the art that although the invention has been described by way of example with reference to a specific embodiment it is not limited to this embodiment and that various alternative embodiments or modifications to the disclosed embodiment could be made without departing from the scope of the invention. For example although the invention has been described with reference to an engine in which the cylinder walls are machined directly into the cylinder block it will be appreciated that the invention is equally applicable to an engine using cylinder liners.

1. An internal combustion engine, comprising:
at least one cylinder bore said cylinder bore having a wall for slidingly supporting a piston, said wall having pockets formed therein for retaining lubricant to reduce friction between the cylinder bore and piston, wherein said pockets are elongate and have axes which are substantially parallel to axis of said cylinder bore, said pockets being located at a first region of said wall supporting the piston when said piston is at its top dead center position.

2. An internal combustion engine according to claim 1, wherein said pockets are between 5 and 60 μm deep, preferably between 5 and 30 μm deep.

3. An internal combustion engine according to claim 2, wherein said pockets are between 0.1 and 4 mm long, preferably between 0.5 and 2 mm long.

4. An internal combustion engine according to claim 3, wherein the pockets are between 5 and 90 μm wide, preferably between 30 and 90 μm wide.

5. An internal combustion engine according to claim 4, wherein said pockets are spaced between 0.5 and 2 mm apart in radial and axial directions with respect to said cylinder bore.

6. An internal combustion engine according to claim 5, wherein those pockets adjacent to each other in an axial direction are radially staggered with their axes offset from each other.

7. An internal combustion engine according to claim 6, wherein said pockets are located at a second region of said wall supporting said piston when said piston is at its bottom dead center position.

8. An internal combustion engine according to claim 7, wherein said cylinder bore wall has a different surface relief formed therein outside said first and second region.

9. An internal combustion engine according to claim 8, wherein said surface relief formed in said cylinder bore wall outside said first and second regions comprises grooves or secondary pockets having axes which are at an angle of 45° or more to the axis of said cylinder bore.

10. An internal combustion engine according to claim 9, wherein said axes of the grooves or secondary pockets are substantially 90° to the axis of said cylinder bore.

11. A method of manufacturing a cylinder for an internal combustion engine, the method comprising:
producing a cylinder bore wall with a required diameter and roundness; and
machining pockets in said cylinder bore wall, which pockets, in use, retain lubricant to reduce friction between said cylinder bore and a piston slidingly supported by said cylinder bore, characterised in that said pockets are elongate and formed with axes which are substantially parallel to the axis of said cylinder bore, said pockets being machined at a first region which, in use, supports said piston when said piston is at its top dead center position.

12. The method according to claim 11, wherein said pockets are machined with a depth of between 5 and 60 μm, and preferably between 5 and 30 μm.

13. The method according to claim 12, wherein said pockets are machined with a length of between 0.1 and 4 mm, and preferably between 0.5 and 2 mm.

14. The method according to claim 13, wherein said pockets are machined with a width of between 5 and 90 μm, and preferably between 30 and 90 μm.

15. The method according to claim 14, wherein said pockets are machined between 0.5 and 2 mm apart in radial and axial directions with respect to the cylinder bore.

16. The method according to claim 15, wherein said pockets are machined adjacent to each other in an axial direction with their axes offset from each other.

17. The method according to claim 16, wherein said pockets are machined at a second region which, in use, supports said piston when said piston is at its bottom dead center position.

18. The method according to claim 17, wherein said cylinder bore wall is machined with a different surface relief outside said first and second regions.

19. The method according to claim 18, wherein grooves or secondary pockets having axes which are at an angle of 45° or more to the axis of said cylinder bore are machined in a cylinder bore wall outside said first and second regions.

20. The method according to claim 19, wherein said grooves or secondary pockets are machined with axes at an angle of substantially 90° to the axis of said cylinder bore.

21. The method according to claim 20, wherein said pockets are machined by honing.

22. The method according to claim 21, wherein said pockets are machined by laser honing.

23. The method according to claim 22, wherein said cylinder bore wall is machined to provide a surface texture of less than 0.1 μm Ra between said pockets after said pockets have been machined in said cylinder bore wall.
